(19) United States
(12) Patent Application Publication
(10) Pub. No.: US 2013/0078481 A1
(43) Pub. Date: Mar. 28, 2013

(54) Metal Plating Polyacetal Compositions

(71) Applicant: Ticona LLC, Florence, KY (US)

(72) Inventors: Robert M. Gronner, Erlanger, KY (US); Hanno Hueckstaedt, Kelkheim (DE)

(73) Assignee: Ticona LLC, Florence, KY (US)

(21) Appl. No.: 13/628,829

(22) Filed: Sep. 27, 2012

Related U.S. Application Data
(60) Provisional application No. 61/539,863, filed on Sep. 27, 2011.

(51) Int. Cl. C25D 5/56; B32B 15/02

(52) U.S. Cl. 428/556; 428/560; 428/561; 205/158

(57) ABSTRACT

Metal coated molded polymer articles are described made from a polyoxymethylene polymer. In accordance with the present disclosure, the molded articles are produced from a polymer composition containing a functionalized polyoxymethylene polymer combined with a metal pigment. The functionalized polyoxymethylene polymer may comprise a polyoxymethylene polymer that has a significant amount of hydroxyl groups present in the terminal positions. The terminal positions can be on the end of the polymer chain or on the side of the polymer chain. In one embodiment, the metal coating is applied to the molded article using an electrolytic plating process. Electrolytic coatings applied to substrates made in accordance with the present disclosure have displayed excellent peel strengths.

### RELATED APPLICATIONS

This application claims filing benefit of U.S. Provisional Patent Application Ser. No. 61/539,863, filed on Sep. 27, 2011, and which is incorporated herein by reference in its entirety.

### BACKGROUND

There has been a continuing desire and need to replace metal parts with plastic parts or plastic composites. Plastic parts, for instance, can provide sufficient strength at a much reduced weight. Further, plastic parts may be less expensive to manufacture and produce in comparison to many metal parts. Further, some plastic materials have properties that are superior to metals. For instance, many plastic materials have better chemical resistance properties than some metals.

In replacing conventional metal parts with plastic parts, those skilled in the art have attempted to create plastic parts that have a metallic look, particularly a polished metallic look. In this regard, in the past, some plastic parts have been plated with metals. For instance, polymers that have been plated in the past include acrylonitrile butadiene styrene, polycarbonate, acrylonitrile butadiene styrene and polycarbonate blends, polystyrene, liquid crystal polymers, and polyethylenimine. Some polymer materials, however, have been found to be unsuited for use in plating applications. For example, some polymer materials have a tendency to degrade when submerged in a plating bath. Many polymer materials also have a tendency to delaminate from a metal layer after plating.

Polyacetal polymers, which are commonly referred to as polyoxymethylenes, have become established as exceptionally useful engineering materials in a variety of applications. Polyoxymethylene polymers, however, are generally considered unsuitable for metal plating, due to their relatively low surface tension and inability to accept metal coatings. In addition, many metal plating processes require an acidic treatment, which is typically too harsh for polyoxymethylene polymers.

Polyoxymethylene polymers, however, possess many useful properties which make the polymers very desirable in applications where conventional metal parts are being replaced or in various other applications where plastic molded parts are preferred. Polyoxymethylene polymers, for instance, have excellent mechanical property, fatigue resistance, abrasion resistance, chemical resistance, and moldability. In view of the above, a need currently exists for molded and shaped polymer articles containing a polyoxymethylene polymer that have a metallic coating and a metallic appearance. A need also exists for a process for plating polyoxymethylene polymers with a metal.

### SUMMARY

In general, the present disclosure is directed to molded products made from a polyoxymethylene polymer and including a metallic coating that provides the product with a polished metal look. In accordance with the present disclosure, it was discovered that by creating a polyoxymethylene polymer with a significant amount of functional groups and then combining the polymer with a metallic pigment, the polymer composition became more amenable to a metal plating process. It was also discovered that the polymer composition exhibits excellent adhesion to metallic coatings.

For example, in one embodiment, the present disclosure is directed to a molded product having a metallic appearance. The molded product includes a shaped article comprised of a polymer composition. The polymer composition comprises a polyoxymethylene polymer wherein at least about 50% of the terminal groups of the polymer are hydroxyl groups. For instance, in one embodiment, at least about 80%, such as at least about 85%, such as at least about 90% of the terminal groups of the polyoxymethylene polymer are hydroxyl groups, such as ethoxy hydroxyl groups. As used herein, terminal groups include end terminal groups and side terminal groups. In one embodiment, for instance, the polyoxymethylene polymer may comprise a copolymer with an increased number of pendant functional groups.

In addition to a polyoxymethylene polymer, the polymer composition further includes a metallic pigment. The metallic pigment may be present in the polymer composition in an amount from about 2% by weight to about 20% by weight. At least a portion of the metallic pigment is exposed on an exterior surface of the shaped article. The metallic pigment may comprise, for instance, an iron pigment, an iron alloy pigment, an aluminum pigment, a copper pigment, a nickel pigment, a silver pigment, a zinc pigment, a brass pigment, and combinations thereof. The metallic pigment, in one embodiment, may be present in the form of plate-like particles. The particles can have, for instance, a particle size of from about 12 microns to about 20 microns and can have an aspect ratio of from about 4:1 to about 50:1.

In accordance with the present disclosure, the molded product further includes a metallic coating located on the exterior surface of the shaped article. The metallic coating has a thickness of from about 0.5 microns to about 100 microns and comprises an elemental metal. For instance, the metallic coating may be made from chromium, nickel, copper, silver, gold or any other suitable metal. In one embodiment, the metallic coating comprises an electrolytic coating. The electrolytic coating may have a thickness of from about 10 microns to about 70 microns.

Of particular advantage, the metallic coating can have a relatively high peel strength. For instance, the peel strength of the metallic coating can be at least about 1 lb/inch, such as at least about 1.5 lbs/inch, such as at least about 2 lbs/inch. In general, the peel strength is less than about 20 lbs/inch, such as less than about 10 lbs/inch.

The shaped article can be made primarily from the polyoxymethylene polymer. For instance, the polyoxymethylene polymer may be contained in the polymer composition in an amount greater than about 40% by weight, such as in an amount greater than about 50% by weight, such as in an amount greater than about 60% by weight, such as in an amount greater than about 70% by weight, such as in an amount greater than about 80% by weight, such as even in an amount greater than about 90% by weight. In general, the polyoxymethylene polymer is contained in the polymer composition in an amount less than about 98% by weight.

The molded product of the present disclosure can be used in numerous different applications. For instance, the molded product may comprise a trim bezel for any suitable end use application. The molded product, for instance, may comprise an automotive trim piece, a consumer appliance part, a bath and shower piece, a cosmetic closure, or the like.

In one embodiment, the molded product may include a second metallic coating. The second metallic coating, for instance, may be located on top of the first metallic coating or may be positioned in between the first metallic coating and the exterior surface of the shaped article. In one embodiment, for instance, the shaped article may include a first metallic coating comprising an electroless coating and may include a second metallic coating comprising an electrolytic coating that is located on top of the electroless coating.

The present disclosure is also directed to a process for metal plating a molded article. The process includes the steps of contacting a shaped article as described above with an electrolytic solution. While the shaped article is in contact with the electrolytic solution, an electric current is passed through the solution which causes metal ions contained in the solution to form a coating on the shaped article.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an interior of a automobile illustrating various molded products that may be made in accordance with the present disclosure;

FIG. 2 is a perspective view of an appliance handle that may be made in accordance with the present disclosure;

FIG. 3 is a perspective view of a shower and bath product that may be made in accordance with the present disclosure; and

FIG. 4 is a perspective view of a cosmetic closure that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polyacetal composition that is well suited to being molded into a particular shape and then coated with a metal. The present disclosure is also directed to a process for producing molded parts containing a polyoxymethylene polymer and that include a metallic coating made from an elemental metal.

Plastic parts coated with a metal are very desirable in many different applications. The metal coating, for instance, can impart a metallic appearance and feel to the plastic part. The metallic coating can also improve various characteristics of the molded part. For instance, the metal coating may improve conductivity, static dissipation, or reduce permeability. As will be described in greater detail below, the present disclosure is directed to a polymer composition containing a polyoxymethylene polymer that displays excellent adhesion to metallic coatings.

In general, the polymer composition of the present disclosure comprises a polyoxymethylene polymer having a relatively high number of functional groups combined with a metal pigment. The combination of a functional polyoxymethylene polymer with a metallic pigment has been found to produce molded parts that not only accept a metallic coating, but also demonstrate good adhesion properties to metallic coatings. Although unknown, it is believed that the functional groups present on the polyoxymethylene polymer may more readily accept metallic coatings and provide better adhesion. The metallic pigment contained in the polymer, on the other hand, is believed to increase local conductivity and nucleation sites during application of a metallic coating to the molded article. It is also possible that the metallic pigment creates surface voids that enhance adhesion to metallic coatings.

The metallic coating applied to the shaped article made from the polymer composition can be formed using different processes. Of particular advantage, the polymer composition of the present disclosure has been found to be well suited for use in electrolytic plating processes. In addition, the polymer composition is also well suited for use in electroless plating processes. In one particular embodiment, for instance, a first metal coating is applied to a molded part made from the polymer composition using an electroless plating process. A thicker metallic coating is then applied to the surface of the shaped article using electrolytic plating.

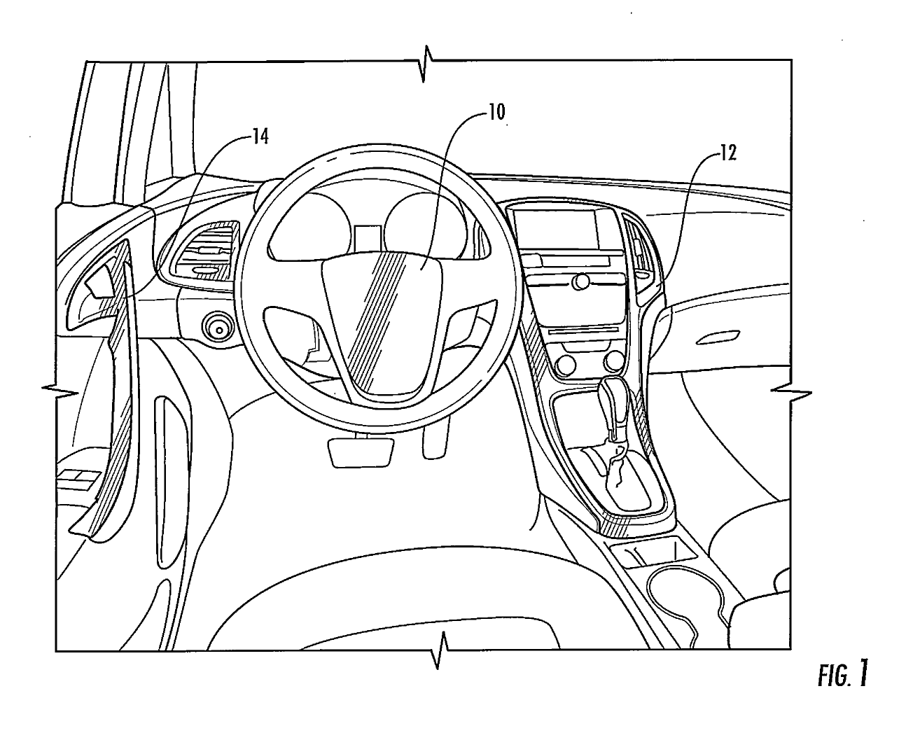

As described above, metal coated plastic parts may be used in many diverse and numerous applications. In one embodiment, for instance, the metal coated parts may be used as trim bezels in a variety of end use applications. In one embodiment, for instance, metal coated parts made according to the present disclosure may be used as automotive trim pieces. Referring to FIG. 1, for instance, the interior of an automobile is shown. As illustrated, a metallic trim bezel or trim piece may be used on the steering wheel column 10 or as a part 12 to surround the interior controls. A metal coated part 14 made in accordance with the present disclosure may also be used as a trim piece on the door of the vehicle.

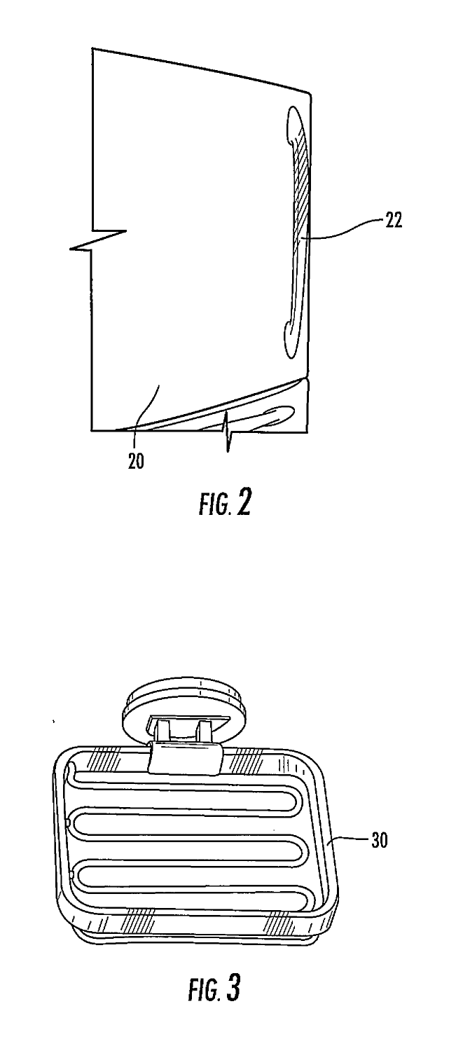

In addition to automotive parts, metal coated products made according to the present disclosure can also be used as appliance parts in almost any consumer appliance product. For instance, referring to FIG. 2, a refrigerator 20 is shown that includes a handle 22 made in accordance with the present disclosure.

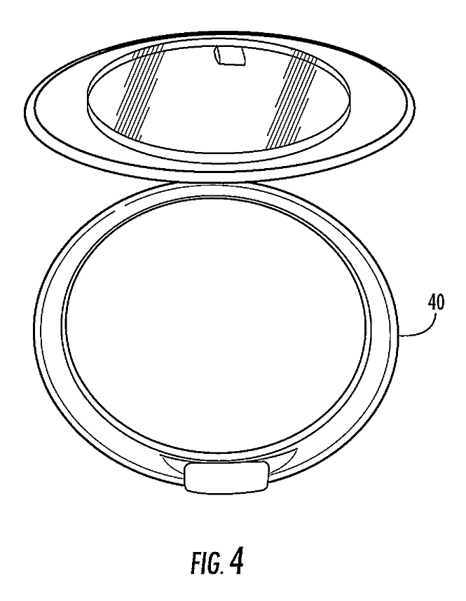

Metallic coated shaped articles made in accordance with the present disclosure may also be used as bath and shower pieces. For instance, referring to FIG. 3, a soap holder 30 is shown that may be made in accordance with the present disclosure. In addition to soap holders, other parts that may be made in accordance with the present disclosure include towel racks, toilet roll holders, toilet levers, housings for shower and tub nozzles, and the like.

In yet another embodiment of the present disclosure, the polymer composition can be coated with a metal to produce cosmetic closures. For instance, FIG. 4 illustrates one embodiment of a cosmetic closure 40 that may be made in accordance with the present disclosure.

As described above, the polymer composition of the present disclosure contains a polyoxymethylene polymer having a relatively high number of functional groups. In one embodiment, for instance, the polyoxymethylene polymer includes a significant number of hydroxyl groups in the terminal position. For instance, in one embodiment, ether end groups on the polyoxymethylene polymer can be replaced with ethoxy hydroxy end groups. The hydroxyl group content of the polyoxymethylene polymer can be further increased by using a comonomer with hydroxyl side groups. In still another embodiment, hydroxyl group concentration may be further increased through the use of a polyoxymethylene moiety with a dendrimer structure. Ultimately, polyoxymethylene polymers can be produced that includes more than about 20 hydroxyl groups per chain, such as more than about 25 hydroxyl groups per chain. In one embodiment, for instance, the polyoxymethylene polymer may include from about 20 hydroxyl groups per chain to about 50 hydroxyl groups per chain.

More particularly, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 50 mmol/kg.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

The preparation of the polyoxymethylene can be carried out by polymerization of polyoxymethylene-forming monomers, such as trioxane or a mixture of trioxane and dioxolane, in the presence of ethylene glycol as a molecular weight regulator. The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted. The above-described procedure for the polymerization can lead to polymers having comparatively small proportions of low molecular weight constituents. If a further reduction in the content of low molecular weight constituents were to be desired, this can be effected by separating off the low molecular weight fractions of the polymer after the deactivation and the degradation of the unstable fractions after treatment with a basic protic solvent. This may be a fractional precipitation from a solution of the stabilized polymer; polymer fractions of different molecular weight distribution being obtained.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

Hₓ[MₘM′ₙO_{z}]yH₂O

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)ₙ—(COOR′)

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)ₘ—CH—(COOR′)₂

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, dimethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain as a rule at least 80%, such as at least 90%, oxymethylene units. Such conventional polyoxymethylenes may be present in the composition as long as the resulting mixture maintains the above amounts of hydroxyl terminated groups and the above amounts of low molecular weight constituents.

The polyoxymethylene polymer present in the composition can generally have a melt volume rate (MVR) of less than 50 cm³/10 min, such as from about 1 to about 40 cm³/10 min, determined according to ISO 1133 at 190° C. and 2.16 kg.

The amount of polyoxymethylene polymer present in the polymer composition of the present disclosure can vary depending upon the particular application. In one embodiment, for instance, the composition contains polyoxymethylene polymer in an amount of at least 40% by weight, such as in an amount greater than about 60% by weight, such as in an amount greater than about 65% by weight, such as in an amount greater than about 70% by weight. In general, the polyoxymethylene polymer is present in an amount less than about 95% by weight, such as in an amount less than about 90% by weight, such as in an amount less than about 85% by weight.

As described above, the polymer composition of the present disclosure comprises the above described polyoxymethylene polymer combined with a metallic pigment. The metallic pigment may comprise any suitable metal that may be compatible with a metallic coating later applied to a molded article made from the polymer composition. Metallic pigments that may be used include an iron pigment, an iron alloy pigment, an aluminum pigment, a copper pigment, a nickel pigment, a silver pigment, a zinc pigment, a brass pigment, and combinations thereof. The metal pigment is combined with the polyoxymethylene polymer in a manner such that at least certain of the metal pigment is located at the surface of a molded article made from the polymer composition.

The metallic pigment may comprise particles having any suitable shape. For instance, the particles may comprise plate-like shaped particles, such as flakes, fibers, and the like.

In one embodiment, for instance, plate-like particles may be used.

The plate-like particles can have an aspect ratio of greater than about 4:1, such as greater than about 8:1, such as from about 10:1 to about 50:1. The plate-like particles can have a median diameter of generally greater than about 12 microns, such as greater than about 14 microns. The plate-like particles can have a median diameter of generally less than about 25 microns, such as less than about 20 microns.

In one embodiment, the metallic pigment may comprise an aluminum pigment that contains elemental aluminum. The aluminum pigment, for instance, can be very thin having a thickness of less than about 1 micron and can have a median diameter as described above. In one particular embodiment, for instance, the aluminum pigment may have a median diameter of from about 12 microns to about 18 microns. The aluminum pigment can have a pronounced flop.

In one embodiment, the metal pigment can contain greater than about 80% by weight metal. The metal pigment can be present alone or in combination with other additives, such as a carrier. For instance, the metal pigment may be present in combination with a thermoplastic polymer, such as a polyolefin, a purified medical white oil, or may be present with a solvent, such as di-isononyl-phtalate.

The metallic pigment can be combined with the polyoxymethylene polymer in various ways. For example, in one embodiment, the metallic pigment can be pre-compounded with the polyoxymethylene polymer. In an alternative embodiment, a master batch containing the metallic pigment may be added during the molding process while the molded part is being produced.

In order to reduce formaldehyde emissions from the polymeric composition, the composition can contain a formaldehyde scavenger, such as a nitrogen containing compound. A formaldehyde scavenger is a compound that reacts and binds formaldehyde. When incorporating a nitrogen containing compound into the composition, the initial formaldehyde content of the polyacetal polymer is desirably low. For example, by using a polyacetal polymer that has an initial formaldehyde content of less than about 500 ppm, the nitrogen composition becomes well dispersed within the polymer.

In general, the total amount of formaldehyde scavengers present in the composition is relatively small. For instance, the formaldehyde scavengers can be present in an amount less than about 2 percent by weight, such as from about 0.01 percent to about 2 percent by weight, such as from about 0.05 percent to about 0.5 percent by weight (which excludes other nitrogen containing compounds that may be present in the composition that are not considered formaldehyde scavengers such as waxes or hindered amines). Any suitable formaldehyde scavenger can be included into the composition including, for example, aminotriazine compounds, allantoin, hydrazides, polyamides, melamines, or mixtures thereof. In one embodiment, the nitrogen containing compound may comprise a heterocyclic compound having at least one nitrogen atom adjacent to an amino substituted carbon atom or a carbonyl group. In one specific embodiment, for instance, the nitrogen containing compound may comprise benzoguanamine.

In still other embodiments, the nitrogen containing compound may comprise a melamine modified phenol, a polyphenol, an amino acid, a nitrogen containing phosphorus compound, an acetoacetamide compound, a pyrazole compound, a triazole compound, a hemiacetal compound, other guanamines, a hydantoin, a urea including urea derivatives, and the like.

The nitrogen containing compound may comprise a low molecular weight compound or a high molecular weight compound. The nitrogen-containing compound having a low molecular weight may include, for example, an aliphatic amine (e.g., monoethanolamine, diethanolamine, and tris-(hydroxymethyl)aminomethane), an aromatic amine (e.g., an aromatic secondary or tertiary amine such as o-toluidine, p-toluidine, p-phenylenediamine, o-aminobenzoic acid, p-aminobenzoic acid, ethyl o-aminobenzoate, or ethyl p-aminobenzoate), an imide compound (e.g., phthalimide, trimellitimide, and pyromellitimide), a triazole compound (e.g., benzotriazole), a tetrazole compound (e.g., an amine salt of 5,5′-bitetrazole, or a metal salt thereof), an amide compound (e.g., a polycarboxylic acid amide such as malonamide or isophthaldiamide, and p-aminobenzamide), hydrazine or a derivative thereof [e.g., an aliphatic carboxylic acid hydrazide such as hydrazine, hydrazone, a carboxylic acid hydrazide (stearic hydrazide, 12-hydroxystearic hydrazide, adipic dihydrazide, sebacic dihydrazide, or dodecane diacid dihydrazide; and an aromatic carboxylic acid hydrazide such as benzoic hydrazide, naphthoic hydrazide, isophthalic dihydrazide, terephthalic dihydrazide, naphthalenedicarboxylic dihydrazide, or benzenetricarboxylic trihydrazide)], a polyaminotriazine [e.g., guanamine or a derivative thereof, such as guanamine, acetoguanamine, benzoguanamine, succinoguanamine, adipoguanamine, 1,3,6-tris(3,5-diamino-2,4,6-triazinyl)hexane, phthaloguanamine or CTU-guanamine, melamine or a derivative thereof (e.g., melamine, and a condensate of melamine, such as melam, melem or melon)], a salt of a polyaminotriazine compound containing melamine and a melamine derivative with an organic acid [for example, a salt with (iso)cyanuric acid (e.g., melamine cyanurate)], a salt of a polyaminotriazine compound containing melamine and a melamine derivative with an inorganic acid [e.g., a salt with boric acid such as melamine borate, and a salt with phosphoric acid such as melamine phosphate], uracil or a derivative thereof (e.g., uracil, and uridine), cytosine and a derivative thereof (e.g., cytosine, and cytidine), guanidine or a derivative thereof (e.g., a non-cyclic guanidine such as guanidine or cyanoguanidine; and a cyclic guanidine such as creatinine), urea or a derivative thereof [e.g., biuret, biurea, ethylene urea, propylene urea, acetylene urea, a derivative of acetylene urea (e.g., an alkyl-substituted compound, an aryl-substituted compound, an aralkyl-substituted compound, an acyl-substituted compound, a hydroxymethyl-substituted compound, and an alkoxymethyl-substituted compound), isobutylidene diurea, crotylidene diurea, a condensate of urea with formaldehyde, hydantoin, a substituted hydantoin derivative (for example, a mono or diC₁₋₄alkyl-substituted compound such as 1-methylhydantoin, 5-propylhydantoin or 5,5-dimethylhydantoin; an aryl-substituted compound such as 5-phenylhydantoin or 5,5-diphenylhydantoin; and an alkylaryl-substituted compound such as 5-methyl-5-phenylhydantoin), allantoin, a substituted allantoin derivative (e.g., a mono, di or triC₁₋₄alkyl-substituted compound, and an aryl-substituted compound), a metal salt of allantoin (e.g., a salt of allantoin with a metal element of the Group 3B of the Periodic Table of Elements, such as allantoin dihydroxyaluminum, allantoin monohydroxyaluminum or allantoin aluminum), a reaction product of allantoin with an aldehyde compound (e.g., an adduct of allantoin and formaldehyde), a compound of allantoin with an imidazole compound (e.g., allantoin sodium dl-pyrrolidonecarboxylate), an organic acid salt].

The nitrogen-containing resin may include, for example, a homo- or copolymer of a polyvinylamine, a homo- or copolymer of a polyallylamine, an amino resin obtainable from a reaction by using formaldehyde (e.g., a condensation resin such as a guanamine resin, a melamine resin or a guanidine resin; a co-condensation resin such as a phenol-melamine resin, a benzoguanamine-melamine resin or an aromatic polyamine-melamine resin), an aromatic amine-formaldehyde resin (e.g., aniline resin), a polyamide resin (e.g., a homo- or copolymerized polyamide such as nylon 3 (poly-β-alanine), nylon 46, nylon 6, nylon 66, nylon 11, nylon 12, nylon MXD6, nylon 6-10, nylon 6-11, nylon 6-12, or nylon 6-66-610, a substituted polyamide containing a methylol or alkoxymethyl group), a polyesteramide, a polyamideimide, a polyurethane, a poly(meth)acrylamide, a copolymer of (meth)acrylamide and other vinyl monomer, a poly(vinyllactam), a copolymer of vinyllactam and other vinyl monomer (for example, homo- or copolymers described in Japanese Patent Application Laid-Open No. 52338/1980 (JP-55-52338A), and U.S. Pat. No. 3,204,014)), a poly(N-vinylformamide) or a derivative thereof (e.g., an N-vinylformamide-N-vinylamine copolymer) (for example, trade name “PNVE Series” manufactured by Mitsubishi Chemical Corporation), a copolymer of N-vinylformamide and other vinyl monomer, a poly(N-vinylcarboxylic acid amide), a copolymer of N-vinylcarboxylic acid amide and other vinyl monomer (for example, homo- or copolymers described in Japanese Patent Application Laid-Open Nos. 247745/2001 (JP-2001-247745A), 131386/2001 (JP-2001-131386A), 311302/1996 (JP-8-311302A) and 86614/1984 (JP-59-86614A), U.S. Pat. Nos. 5,455,042, 5,407,996 and 5,338,815), and trade names “Noniolex” and “Cleatech” manufactured by Showa Denko K.K.), and others.

The nitrogen-containing compounds may be used singularly or in combination.

In one particular embodiment, the preferred nitrogen-containing compound includes a guanamine compound (e.g., adipoguanamine, and CTU-guanamine), melamine or a derivative thereof [particularly, melamine or a melamine condensate (e.g., melam, and melem)], a guanidine derivative (e.g., cyanoguanidine, and creatinine), a urea derivative [e.g., biurea, a condensate of urea with formaldehyde, allantoin, and a metal salt of allantoin (such as allantoin dihydroxyaluminum)], a hydrazine derivative (e.g., a carboxylic acid hydrazide), a nitrogen-containing resin [e.g., an amino resin (an amino resin such as a melamine resin or a melamine-formaldehyde resin; a crosslinked amino resin such as a crosslinked melamine resin), a polyamide resin, a poly(meth)acrylamide, a poly(N-vinylformamide), a poly(N-vinylcarboxylic acid amide), and a poly(vinyllactam)]. Among them, in particular, combination use of at least one member selected from the group consisting of biurea, allantoin, a metal salt of allantoin, a carboxylic acid hydrazide and a polyamide resin, and a guanamine compound having a unit represented by the above-mentioned formula (I) can bring in significant reduction of an amount of formaldehyde generated from the shaped article.

In one embodiment, the composition may contain a nucleant. The nucleant, for instance, may increase crystallinity and may comprise an oxymethylene terpolymer. In one particular embodiment, for instance, the nucleant may comprise a terpolymer of butanediol diglycidyl ether, ethylene oxide, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

In one embodiment, the composition may also contain one or more lubricants. The lubricant may comprise a polymer wax composition. Lubricants that may be included in the composition include, for instance, N,N′-ethylene bisstearamide. In one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount from about 0.01% to about 5% by weight. For instance, a lubricant can be present in an amount greater than about 0.1% by weight, such as in an amount from about 0.1% to about 1% by weight. The above polyethylene glycol polymer can also be present in an amount up to about 5% by weight. For instance, the polyethylene glycol polymer can be present in an amount from about 0.1% to about 2% by weight, such as from about 0.5% to about 1% by weight.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount of from about 0.01% to about 1% by weight.

The polymer composition of the present disclosure can be used to produce various molded parts. The parts can be formed through any suitable molding process, such as an injection molding process or through a blow molding process. Polymer articles that may be made in accordance with the present disclosure include knobs, door handles, automotive panels, interior automotive parts such as bezels, consumer appliance parts, and the like without limitation.

After a shaped article is formed from the polymer composition, the shaped article is then coated with one or more metallic layers in accordance with the present disclosure. The metallic layers may be applied to the shaped article using various different processes. For example, the metallic coating can be applied to an exterior surface of the molded article using electroless plating, electrolytic plating, a combination of both, or the like.

In one embodiment, for instance, an electrolytic coating may be applied to the shaped article. To form an electrolytic coating, the shaped article is contacted with a solution containing metal ions. The metal ions may comprise, for instance, chromium, nickel, copper or the like. During contact with the solution containing the metal ions, a current is fed through the solution causing the metal ions to reduce and form a coating on the molded article. This process can occur within an electrolytic cell or bath.

In order to electrolytically plate metals on a polymer article, the polymer article should possess some conductivity properties. In accordance with the present disclosure, the metallic pigment may provide sufficient conductivity for electrolytic plating to occur.

In an alternative embodiment, however, the molded article may first include an electroless coating followed by electrolytic plating. In order to electroless plate a molded article, the molded article may optionally first be pretreated. In one embodiment, for instance, the molded article may be subjected to an etching process. For instance, in one embodiment, an acid, such as chromic acid, may be used to etch the surface of the molded article. Etching leaves a pitted surface and may expose more of the metallic pigment. Of particular advantage, however, molded articles made according to the present disclosure containing a metallic pigment in combination with a polyoxymethylene polymer having a relatively large amount of functional groups may not have to be etched in order to apply a metal coating to the part. In fact, exposing a polyoxymethylene polymer to many acid etch processes may degrade the polymer beyond desirable limits.

In one embodiment, as opposed to etching the surface of the molded article, the molded article may be subjected to a pretreatment that produces or creates further functional groups on the surface of the article and/or renders the surface more hydrophilic. In one embodiment, for instance, pretreatment may comprise sulfonating the surface of the molded article. In one particular embodiment, for instance, the molded article may be treated with vapor phase sulfur trioxide. For instance, in one embodiment, the molded article may be contacted with a gas containing sulfur trioxide for a time of from about 0.5 minutes to about 10 minutes in a pressurized vessel. In general, the concentration of the sulfonation agent in the gas atmosphere can range from about 5% to about 100% by volume, such as from about 10% to about 50% by volume.

In addition to contacting the molded article with sulfur trioxide, various other sulfonating agents may be used. For instance, sulfuric acid is another known sulfonating agent.

Contacting the molded article with a sulfonating agent produces sulfonic groups on the surface of the molded article. The sulfonic groups may change the hydrophobic nature of the surface of the article and/or may provide binding sites for metals.

After pretreating the surface of the molded article with a sulfonating agent (if desired), in one embodiment, the molded article may be contacted with an activator prior to the electroless plating process. Any suitable activator may be used that further increases the conductivity of the article and/or provides further sites for binding with a metal coating. In some embodiments, however, treatment with an activator may not be necessary.

In one embodiment, the activator may comprise palladium. For instance, in one embodiment, the exterior surface of a molded article may be contacted with a solution containing a palladium salt, such as palladium chloride. For instance, in one embodiment, the solution may contain palladium chloride, stannous chloride and hydrochloric acid. In an alternative embodiment, the molded article is contacted with a solution containing ionic palladium.

In order to form a metal coating on the molded article using an electroless plating method, the molded article is typically dipped or otherwise contacted with a solution containing metal ions and a reducing agent. The metal ions, for instance, may comprise chromium, nickel, copper, brass, cadmium, gold, silver, platinum, zinc and the like. The reducing agent causes the metal ions to reduce and form a thin coating on the surface of the molded article. For instance, the coating may have a thickness of from about 0.5 microns to about 30 microns, such as from about 1 micron to about 10 microns. During electroless plating, the plating solution or bath generally contains metal ions in an amount from about 0.5% to about 30% by volume, such as from about 0.5% to about 10% by volume. Any suitable reducing agent may be used to initiate the process. The reducing agent, for instance, may comprise an aldehyde.

In one embodiment, after an electroless coating is applied to the molded article, the article is then subjected to electrolytic plating to form a thicker and more mechanically robust coating on the part. During electrolytic plating, a metallic coating may be applied to the surface of the molded article that has a thickness of generally greater than about 5 microns, such as greater than about 20 microns, such as greater than about 30 microns, such as greater than about 40 microns, such as greater than about 50 microns. In general, the electrolytic coating may have a thickness of from about 10 microns to about 100 microns.

Of particular advantage, when applying electrolytic coatings to molded articles in accordance with the present disclosure, the coating displays excellent peel strength values considering the molded article contains a polyoxymethylene polymer. For instance, the electrolytic coating may have a peel strength of greater than about 11b/inch, such as greater than about 1.5 lbs/inch, such as even greater than about 2 lbs/inch.

The present disclosure may be better understood with reference to the following examples.

### EXAMPLES

Various polyoxymethylene compositions were injection molded into plaques, coated with a metal, and then tested. The plaques had dimensions of 3″×4″×⅛″. The following plaques were produced:

Sample No. 1: Conventional polyoxymethylene polymer containing less than about 20 mmol/kg hydroxy groups.

Sample No. 2: Conventional polyoxymethylene polymer containing less than about 20 mmol/kg hydroxy groups.

Sample No. 3: Polyoxymethylene polymer having about 54 mmol/kg hydroxide content

Sample No. 4: The polyoxymethylene polymer of Sample No. 1 combined with an aluminum pigment

Sample No. 5: Polyoxymethylene polymer having about 80 mmol/kg hydroxide content combined with aluminum pigment

For Sample Nos. 4 and 5 above, an aluminum pigment was combined with the polyoxymethylene polymer in an amount of 2% by weight. The aluminum pigment had a particle size of from about 24 microns to about 31 microns. The aluminum pigment contained a binder.

Each of the above plaques was then subjected to a vapor phase pretreatment with sulfur trioxide. In particular, the plaques were first subjected to an ultrasonic aqueous wash followed by air drying. The plaques were then placed in a chamber and exposed to a mixture of air and sulfur trioxide at a pressure of 1 ATM for from 1.5 minutes to 5 minutes. The temperature during contact with the sulfur trioxide was maintained at 140° F. Afterwards, the plaques were neutralized by washing in distilled water.

One set of the plaques was then coated with copper in an electroless plating process. A second set of plaques was coated with nickel in an electroless plating process.

Copper plating solutions were obtained from MacDermid, Inc. under the tradename “M-System Omega”. The nickel plating solutions were also obtained from MacDermid, Inc. under the tradename “J-64”. Prior to electroless plating, each plaque was contacted with an activator in a solution at a pH of 4 to 5 and then contacted with an accelerator in a solution at a pH of 13. After electroless plating, the plaques were dried and the metal coating was tested for adhesion.

Adhesion for the electroless coatings was tested by both the cross-hatch test (ASTM Test B905) and by thermal cycling. For the cross-hatch test, the coating was scratched with a sharp blade in a “X” pattern. If none of the coating peeled back, the test is considered a pass. If the coating peels back, it is considered a fail. During the thermal cycling test, the plaques are put through eight cycles from 32° F. to 188° F. If the plaque shows no evidence of peeling, it is considered a pass. Any evidence of peeling is considered a failure. All of the electroless coatings passed both the cross-hatch test and the thermal cycling test.

One set of samples that were coated with copper using the electroless plating process was then subjected to an electrolytic plating process. During electrolytic plating, the copper-coated plaques were placed in an electrolysis bath having an acidic pH and containing copper ions. An electric current was passed through the electrolysis cell for 80 minutes in order to deposit a copper coating on the substrate. The copper coating was from 5 microns to 75 microns in thickness. The plaques were then washed in distilled water and dried prior to testing for adhesion.

The plaques that were electrolytically plated were then subjected to a peel test (ASTM Test B533).

To prepare the samples for the peel test, a strip 0.25″ wide and 2 to 3″ long was cut in the copper coating using a sharp blade. One end of the coating was peeled back far enough to allow mounting in a tensile testing machine. The plaque was mounted to the base. The force required to peel off the plating was measured. The test was completed three times for each sample and the average force was determined. The following results were obtained:

| Sample | Peel Test of Electrolytic Copper Coating (lbs/in) |
|---|---|
| 1 | coating fell off on cutting - failed peel test |
| 2 | coating fell off on cutting - failed peel test |
| 3 | coating fell off on cutting - failed peel test |
| 4 | 0.6 |
| 5 | 2.1 |

During electrolytic plating, it was noticed that the solution in the electrolysis bath had a tendency to remove the copper electroless coating.

As shown above, the electrolytic coating applied to Samples 1 through 3 all failed the peel test. Sample No. 4 which contained polyoxymethylene polymer combined with alumina particles observed a weak peel strength. Sample No. 5 made in accordance with the present disclosure, however, displayed a peel strength that was three times the peel strength of Sample No. 4. The examples show that synergy occurs when a polyoxymethylene polymer containing a relatively high amount of hydroxyl groups is combined with metal particles and coated using electrolysis.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A molded product having a metallic appearance comprising:
a shaped article comprised of a polymer composition, the polymer composition comprising a polyoxymethylene polymer having terminal groups and wherein at least about 50% of the terminal groups are hydroxyl groups, the polymer composition further containing a metallic pigment, the metallic pigment being present in the polymer composition in an amount from about 2% by weight to about 20% by weight, at least certain of the metallic pigment being exposed on an exterior surface of the shaped article; and
a metallic coating located on the exterior surface of the shaped article, the metallic coating having a thickness of from about 0.5 microns to about 100 microns, the metallic coating comprising an elemental metal.

2. A molded product as defined in claim 1, wherein the hydroxyl groups comprise ethoxy hydroxyl groups.

3. A molded product as defined in claim 1, wherein at least about 80% of the terminal groups on the polyoxymethylene polymer are hydroxyl groups.

4. A molded product as defined in claim 1, wherein the metallic pigment comprises plate-like particles having a particle size of from about 12 microns to about 20 microns.

5. A molded product as defined in claim 4, wherein the plate-like particles have an aspect ratio of from about 1:4 to about 1:50.

6. A molded product as defined in claim 1, wherein the metallic pigment comprises an aluminum pigment.

7. A molded product as defined in claim 1, wherein the metallic coating comprises chromium, nickel, or copper.

8. A molded product as defined in claim 1, wherein the metallic coating comprises an electrolytic coating.

9. A molded product as defined in claim 1, wherein the polyoxymethylene polymer is present in the shaped article in an amount from about 40% to about 98% by weight.

10. A molded product as defined in claim 3, wherein the polyoxymethylene polymer comprises a copolymer.

11. A molded product as defined in claim 8, wherein the metallic coating has a peel strength of at least about 1 lb/inch.

12. A molded product as defined in claim 8, wherein the metallic coating has a peel strength of at least about 1.5 lbs/inch.

13. A trim bezel comprising the molded product defined in claim 1.

14. An automotive trim piece, a consumer appliance part, a bath and shower piece, or a cosmetic closure comprising the molded product defined in claim 1.

15. A molded product as defined in claim 8, further comprising a second metallic coating on an exterior surface of the shaped article, the second metallic coating comprising an electroless coating, the electroless coating being positioned in between the exterior surface of the shaped article and the electrolytic coating.

16. A process for metal plating a molded article comprising:
contacting a molded article with an electrolysis solution, the molded article being comprised of a polymer composition, the polymer composition comprising a polyoxymethylene polymer having terminal groups and wherein at least about 50% of the terminal groups are hydroxyl groups, the polymer composition further containing a metallic pigment, the metallic pigment being present in the polymer composition in an amount from about 2% by weight to about 20% by weight, at least certain of the metallic pigment being exposed on an exterior surface of the shaped article, the electrolysis solution containing metallic ions;
passing an electric current through the electrolysis solution while contacting the molded article in order to plate the exterior surface of the molded article with an elemental metal.

17. A process as defined in claim 16, wherein prior to contacting the molded article with the electrolysis solution, the molded article is subjected to an electroless process in which the molded article is contacted with a solution containing metal ions and a reducing agent, the reducing agent causing the metal ions to form an electroless metallic coating on the molded article.

18. A process as defined in claim 16, wherein the elemental metal coating produced on the molded article comprises chromium, nickel or copper.

19. A process as defined in claim 16, wherein the metallic pigment comprises plate-like particles, the metallic pigment comprising an aluminum pigment, and wherein at least about 80% of the terminal groups of the polyoxymethylene polymer are hydroxyl groups.

20. A process as defined in claim 17, wherein the molded article is exposed to SO₃ prior to being contacted with the solution containing the metal ions and the reducing agent.

21. A process as defined in claim 16, wherein the coating on the molded article has a thickness of from about 5 microns to about 100 microns.
